(19) United States
(12) Patent Application Publication
(10) Pub. No.: US 2009/0228123 A1
(43) Pub. Date: Sep. 10, 2009

(54) DISTRIBUTION OF PLAYLISTS AMONG AUDIO REPLAY DEVICES

(75) Inventor: Wilhlemus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,456

(22) PCT Filed: Aug. 8, 2005
(86) PCT No.: PCT/IB05/52628

§ 371 Date: Feb. 9, 2007

(30) Foreign Application Priority Data
Aug. 12, 2004 (EP) 04103895.1

(51) Int. Cl. G06F 17/00

(52) U.S. Cl. 700/94

(57) ABSTRACT

Playlist information is distributed for use in a system of a plurality of audio replay devices. Each device comprises local storage for storing tracks. Playlist information items are generated, each for a respective track, each indicating a system wide playlist to which the respective track belongs and a sequential position of the track in the system wide playlist. Individual audio replay devices are coupled to a source device for downloading selected playlist information items, for updating a local playlist in the individual audio replay device. The updated local playlist is used to control selection and a sequence of play of tracks by the individual audio replay device. Preferably, the playlist information item indicates the sequential position of the track in the system wide playlist and the local playlist by means of a sequence number for the track in the playlist, the sequence numbers of the playlist information items being set in the defining step so that space is left for later definition of playlist information items with sequence numbers that correspond to insertion among tracks in a previously defined playlist. Preferably at least one of the playlist information items contains playlist specific virtual editing information, for editing the track that is associated with the at least one of the playlist information items according to the virtual editing information and replaying the edited track when the playlist is replayed in a device.

The invention relates to audio replay equipment and more generally to a system of audio play devices. More particularly, the invention relates to the use of playlists in such audio replay equipment and the propagation of playlist information to different audio replay devices.

Playlists provide a convenient mechanism for selection of music tracks. Today's audio equipment has the capability of storing vast numbers of tracks, which presents users with the problem of increasingly longer searches for the tracks they want to play. With the limited interface capabilities of portable audio equipment this is often awkward or even impossible. The need to search can be avoided by selecting a playlist instead of selecting individual tracks. A playlist defines a series of tracks that will be played in succession when the playlist is selected. Typically, a playlist represents the personal choice of a user, both of specific tracks and the sequence in which these tracks should be played when the playlist is selected.

PCT patent application No. WO03/023781 describes an apparatus for automated composition and management of playlists. The playlists are composed on a personal computer (PC) and downloaded into a (portable) personal audio device, together with the tracks. The system uses a set of records that each refer to a respective track. Playlists are defined by means of index fields in the records, an index field for a track pointing to the record for the next track in a playlist.

PCT patent application No. WO01/67753 also describes an apparatus for automated composition of playlist. Tracks are automatically added to playlists on the basis of properties that have been defined for the tracks e.g. in terms of the genre of music contained in the track, the artist that performs the track etc. Composition of playlist by means of automatic property based selection simplifies eases the work of playlist users, but of course it removes some of the possibilities for personal choice, such as selection of combinations of tracks that do not have the same property, or the selection of the sequence of the tracks in the playlist.

Often a user possesses a plurality of personal audio devices, for example one for use in a car, one or more portable devices, players in different rooms of a house, players combined with other equipment such as television sets etc. These devices may each be equipped with storage for music tracks and with connections for loading tracks from other devices into storage. Thus, it is made possible to exchange audio tracks between different devices, with a colleague at work, with friends, from the Internet or between different devices that are owned by the same person.

From a user point of view it is desirable that the same playlists should be available on all personal audio devices that a user owns. This presents problems because of the decentralized nature of a collection of personal audio devices. When a playlist can be altered on a particular device independent of the other devices different versions of the playlist may arise. Of course it is possible to download an altered playlist to another device once such a device is coupled to the particular device where the playlist has been altered, or to an intermediate device from which the playlist can be forwarded once the intermediate device is connected to an audio replay device.

Among others, it is an object of the invention to provide for a method of distributing playlist information, and components of a system of audio replay devices that support such a method, so that the method permits distribution of playlist information that defines a sequence of tracks in the playlists but does not require that complete playlists must be distributed.

Among others, it is an object of the invention to provide for a method of distributing playlist information so that playlists can be updated without requiring that complete playlists must be downloaded and/or causing a dependence on a sequence in which updates are distributed.

The method, system, apparatus and device according to the invention are set forth in the independent claims. According to the invention, the playlist is defined by different items of playlist information that are provided for respective tracks of the playlist. Each item of playlist information defines a position of the associated track in the playlist. When an individual audio replay device is connected to a source of playlist information only selected ones of the items of playlist information are downloaded. The downloaded tracks are stored in storage, such as in an optical or magnetic storage medium or a flash memory and the playlist information is stored in memory. The storage that is used for the tracks may also be used as memory for the playlist information, but alternatively a separate memory may be used.

In this way on one hand downloading of complete playlists is avoided, and with it the risk of inconsistencies due to the diversity of paths along which playlist information may reach an audio replay device, and other the other hand the ability of the user to selected both the content of the playlist and the sequence of the tracks in the playlist with complete freedom is preserved.

Typically only selected tracks are downloaded, such as tracks that are not yet stored in the audio replay device or tracks that a user has selected for download into the particular audio replay device. Typically only items of playlist information for the downloaded tracks are loaded. Preferably, an item of playlist information for a track is included in the file that contains the track and that is downloaded to download the track. Preferably, the each item of playlist information indicates the position of the associated track by means of an assigned sequence number that has been selected to that unused sequence numbers remain available between sequence number that have been assigned to tracks in the playlist. In this case, sequence numbers for which no track is available in the audio replay device are ignored: the audio equipment simply continues with the track that has the lowest next sequence number.

Preferably, sequence numbers are assigned using an open system wherein a default value is initially assigned at least implicitly to a least significant part of each sequence number. A sequence numbers with a deviating value of the least significant part is assigned only when necessary to assign a sequence number to insert a track in a playlist between previously defined tracks. The default values need not be transmitted to the audio replay devices, because generation of the default values may be postponed until needed to distinguish from later inserted sequence numbers.

Preferably, virtual editing information is included in the item of playlist information for a track to define for example what part of a track should be played as part of the playlist. One or more playlists may be defined the item of playlist information identifying multiple different playlists to which the track belongs. Preferably, it is supported that a track may belong to more than one playlist at a time.

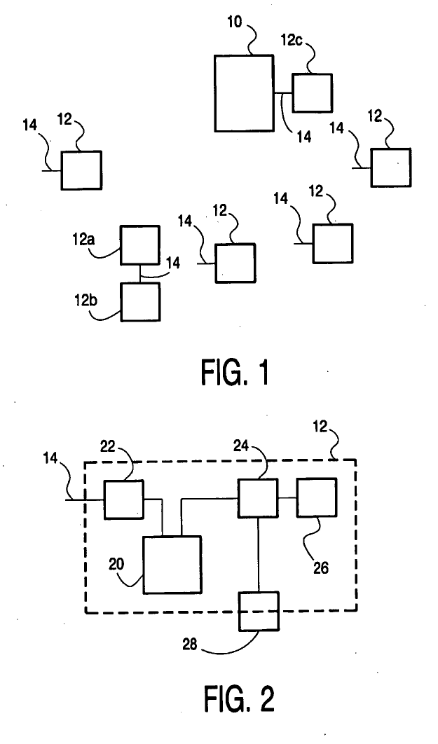

FIG. 1 shows a system containing audio replay devices

FIG. 2 shows an audio replay device

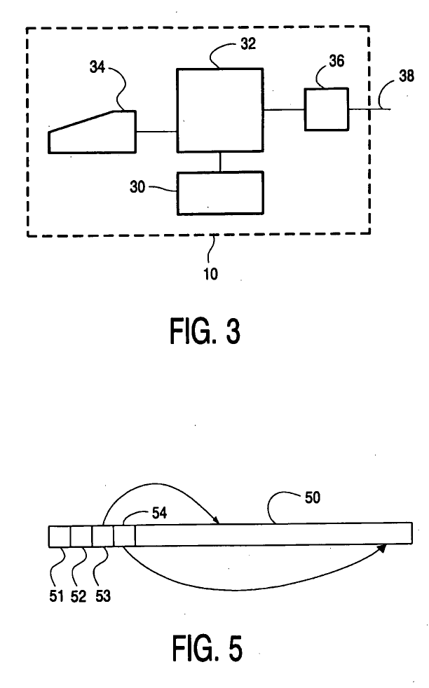

FIG. 3 shows a central distribution apparatus

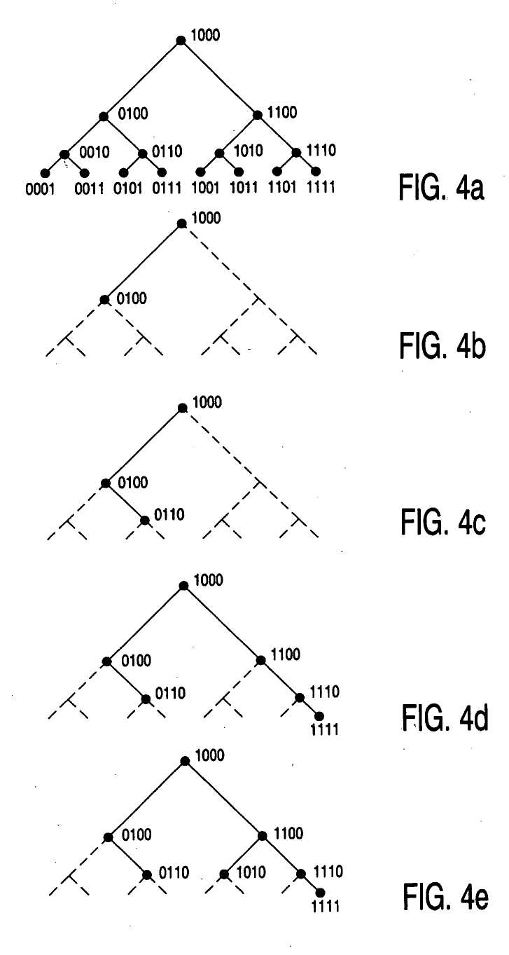

FIGS. 4a-e illustrate selection of sequence numbers

FIG. 5 shows a layout of an information item

FIG. 1 shows a system containing audio replay devices 12 and a central distribution apparatus 10. Each audio replay device 12 has connection 14 for exchanging music tracks and playlist information with other audio replay devices 12 or central distribution apparatus 10. By way of example two audio replay devices 12a,b are shown connected via their connection and one audio replay device 12c is shown connected to central distribution apparatus 10. Any type of connection 14 may be used, including for example a wireless connection (such as an infrared connection using an infrared transmitter and receiver) or a wired connection using connectors (not shown) on the devices. In a more advanced example, an indirect connection via the Internet may be used. Any type of connection is symbolized by a single line 14.

FIG. 2 shows an embodiment of an audio replay device 12. The device contains a storage device 20, a read and/or write circuit 22, a replay circuit 24, a rendering unit 26 and a user interface 28. Storage device 20 contains for example a flash memory circuit, or a magnetically writable and readable medium etc. Read and/or write circuit 22 is coupled between connection 14 and storage device 20. Replay circuit 24 is coupled between rendering circuit 26 and storage device. User interface 28 is coupled to replay circuit 24.

Audio replay device 12 supports a stand-alone audio operation mode, wherein replay circuit 24 retrieves audio signal data from storage device 20 and uses the audio signal data to control an audio output such as a loudspeaker via rendering circuit 26. In the stand-alone audio operation mode, audio replay device is operable to receive a playlist selection command from user interface 28. Playlist selection is performed for example by showing names of available playlists on a display screen of user interface 28 and indication of one of the displayed names, or by speaking a playlist name to a speech recognition component of user interface 28 etc. Replay circuit 24 receives an identification of the selected playlist, retrieves identifications about tracks that are included in the playlist (for example from storage device 20), retrieves the audio signal data of the included tracks from storage device 20 and uses the audio signal data to control the audio output via rendering circuit 26

Audio replay device 12 supports a download operation mode, wherein connection 14 is coupled to another audio replay device 12 or to central distribution apparatus 10. In the download operation mode read and/or write circuit 22 receives tracks of data, such as audio signal data for respective audio tracks from connection 14, as well as items of playlist information for the received tracks. In an embodiment the item of playlist information for each respective track is part of a file that also includes the audio signal data for the track. In another embodiment, the item of playlist information is separate from the track.

An item of playlist information may be represented for example as a record containing fields for a playlist identifier and a sequence position indicator. In an embodiment read and/or write circuit 22 writes items of playlist information in storage device 20 and replay circuit 24 retrieves the items to determine which tracks belong to a requested playlist in which sequence. In this embodiment replay circuit 24, when commanded to replay a specific playlist, searches for items of playlist information that identify that specific playlist and plays the tracks associated with the items of playlist information in the order defined by the items.

In another embodiment read and/or write circuit 22 compiles the items of playlist information into playlists, wherein each playlist contains for example records, each record having a fields for an identifier that identifies a track and a field for a sequence number of that track in the playlist. When the second embodiment is used, read and/or write circuit 22, upon receiving an item of playlist information reads the playlist identifier from the item, searches for the playlist identified by the item and inserts an identifier for the track that is associated (e.g. received with) the item of playlist information in the playlist, together with information about the sequence number. In this embodiment replay circuit 24, when commanded to replay a specific playlist, searches for the playlist and plays the tracks that are identified in the playlist in the order defined by the playlist.

FIG. 3 shows an embodiment of central distribution apparatus 10. The apparatus contains a storage device 30 for tracks, a playlist editing computer 32 with a user interface 34 and a write circuit 36 coupled to an output 38 for coupling to connections 14 (not shown) of audio replay devices 12 (not shown). Storage device 30 stores tracks of audio signal data, which may have been downloaded from the Internet for example, or are stored on an optical disc etc. Computer 32 is programmed to compose playlists, for example under direction of commands from user interface 34. Each playlist has a name and defines a number of tracks from memory device 20 and a sequence of replay of these tracks. The playlist is stored for example in storage device 30. Optionally, central distribution apparatus 10 adds a respective time stamp to each track in a playlist to indicate the temporal sequence in which tracks have been added to the playlist. This may be used to resolve conflicts. Also optionally, the playlists are represented by including playlist information items in files for respective tracks, so that the file for each track contains one or more playlist information items that indicate that the track belongs to one or more playlists and its sequence positions in these playlists.

FIG. 4a-e use a binary tree to illustrate an embodiment of a method of selecting numbers to indicate the sequence position of a track in a playlist. In this embodiment six four bit binary numbers 1000, 0100, 0110, 1100, 1110, 1111 are used to indicate the sequence position of tracks in a play list.

FIG. 4a shows a notional full binary tree that is used to explain a search for sequence numbers. The full tree has nodes and each node, except the lowest level nodes, branches to two subtrees, each with a top node which again branch to two subtrees and so on. If the top-level tree contains 2ⁿ−1 nodes then its subtrees each contain 2ⁿ⁻¹−1 nodes and so on. Binary numbers are assigned to the nodes, so that the more significant bits of the number assigned to a node identifies the position of the subtree to which the node belongs and the less significant bits identify the position of the node in the subtree. The top node of a subtree with 2^{m}−1 nodes is assigned the binary number comprised of the most significant bits that identify the subtree followed by a binary 1 and m−1 binary zeros for the less significant bits. One sub-subtree of the subtree has nodes with assigned numbers comprised of the most significant bits that identify the subtree followed by a binary zero. The other sub-subtree of the subtree has nodes with assigned numbers comprised of the most significant bits that identify the subtree followed by a binary one.

FIGS. 4b-e illustrate how the sequence numbers are selected incrementally by successively selecting the numbers of nodes from the full tree that have not previously been used as sequence numbers. Initially when a first sound track is selected for a playlist the track is given the number assigned to the top of a tree. When a second sound track is added to the playlist this sound track is assigned sequence number of the top node of the left or the right subtree, dependent on whether this second sound track should be played before or after the first sound track. After this two nodes of the tree are in use, as shown in FIG. 4b, where unassigned nodes are symbolized by dashed lines.

Numbers are assigned to subsequently added tracks each time by descending the tree from the top until a node is encountered whose number has not yet been assigned to a track. Previously assigned numbers are not changed. During the descent, each time a branch to one subtree or another is chosen dependent on whether the newly added track should be played before or after the track that has the number associated with the node from which one descends. Thus, for example, if a third track should be played before the track with sequence number 1000 and after the track with sequence number 0100, one has to descend two branches of the tree encountering a node with assigned number 0110 to be used for the third track. This is illustrated in FIG. 4c. FIG. 4d shows the nodes of which the numbers are used when three successively further added tracks have to be played each time later than all preceding tracks. FIG. 4e shows the nodes of which the numbers are used when a further track is added to the playlist, for replay after the track with the number 1000 and before the track with the number 1100.

It must be understood that the trees of FIGS. 4a-e merely serve to illustrate the principle of this technique of selecting sequence numbers for tracks. In an implementation computer 32 may store information corresponding to the tree structure, including pointers for each track, pointing to the tracks that have sequence numbers corresponding to a next lower level in the tree. In this case the search for a sequence number involves starting with a topmost track of the tree, comparing its position in the intended playlist with the position of the topmost track. If the new track is to be played earlier its most significant bit is assigned a binary zero value, else it is assigned a binary one value. Next this process is repeated for successively less significant bits using either the track pointed at to represent one branch of the tree or the other, dependent on the outcome of the comparison. Once there is not yet any track for such a branch the number may be completed by adding a binary one and subsequent binary zero's.

However, there it is no obligation to use selection that is equivalent to descent along the tree structure, although this is usually the implementation that requires the least amount of resources. The point is merely that previously assigned numbers are not changed, or if they are changed they are changed by adding less significant bits that have a default value. As an alternative, for example, the sequence numbers that have been assigned to tracks could be arranged in a local playlist in central apparatus 10 in the order of the playlist, and the addition of a new sequence number could be performed by user selection of the desired position in the playlist, retrieval of a first and second sequence number of the next preceding and following track in the playlist, and selection of a new sequence number for the new track dependent on the first and second sequence number. In principle any number between this first and second sequence number may be used, but preferably a number substantially midway between these sequence numbers is selected. When it is desired to use a minimum number of most significant bits in the sequence numbers to distinguish tracks, preferably the midway sequence number with the most successive less significant zeros is selected.

Also, without deviating from the invention, the most significant part of sequence numbers of an initial set of tracks in the playlist may be assigned in one step in central apparatus 10 by conventional numbering, a method like that described with the aid of FIGS. 4a-e being used only for assigning sequence numbers to later added tracks. In this case substantially equidistant initial sequence numbers are assigned to the tracks in the initial playlist. This may be done for example by determining the minimum number of bits that is needed to distinguish the number of tracks in the initial play list, associating different pre-numbers with this number of bits are with these tracks, and using the pre-numbers as most significant part of the sequence numbers.

When an audio replay device 12 is coupled to output 38 apparatus 10 causes selected tracks to be downloaded to the audio replay device 12. The selected tracks may be selected for example by a user via user interface 34, or tracks for which it has not yet been recorded that they have been downloaded into the connected audio replay device 12 may be selected for downloading for example. Alternatively a collection of tracks may be selected by a user and these tracks, or selected ones of these tracks for which it has not yet been recorded that they have been downloaded into the connected audio replay device 12, may be downloaded. For each downloaded track apparatus 10 also downloads one or more items of playlist information to replay device 12. Preferably the item or items of playlist information is or are embedded in the same file as the audio track e.g. in the form of an ID3 tag, at least during download.

Preferably one or more audio replay device 12 in turn are able to send selected tracks and playlist information for download to other audio replay devices 12. In this way a user need not connect all his or her audio replay devices 12 to the central apparatus 10 to download tracks and playlist information. Instead a local contact between a download capable device and another device suffices. Thus, for example a portable audio replay device may be used to download tracks to a car radio.

Each item of playlist information contains an identification of a playlist to which the tracks belongs and sequence information of the track in the playlist, for example in the form of the number selected by the algorithm described in the preceding (and possibly a timestamp in order to help resolve conflicts when different numbers are presented to the device; in this case the number with the most recent time stamp is used). Audio replay device 12 uses the numbers to determine the sequence of replay of tracks in a playlist. The track from the playlist with the lowest number is played first, followed by the track with the next higher number and so on.

It should be noted that the numbers in general will not be consecutive if tracks are added to a playlist in an arbitrary order. In the example of FIG. 4a-e numbers, 0100, 0110, 1000, 1100, 1110, 1111, corresponding to decimal numbers 4, 6, 8, 12, 14 are used for example. Audio replay device 12 skips numbers for which no tracks are stored in audio replay device 12, i.e. numbers 1, 2, 3, 5, 7 etc in the preceding example. Thereby the device automatically skips tracks in the original playlist (created on 10) that are not transferred to the portable device.

This has the advantage that tracks can be inserted later in the playlist without having to change the numbers that have been downloaded for previous tracks. As a result, no extensive updates to audio replay devices 12 are needed. Old playlists can be updated merely by adding new tracks and their associated sequence information, without downloading playlist information for previously loaded tracks in the playlist. Furthermore, tracks may be downloaded at an arbitrary time with respect to the time of update of the playlist in central apparatus 10. If the user has assigned a sequence position to a first track before the user has assigned a sequence position to a second track, the second track and the number used to indicate its sequence position may be loaded before the first track (e.g. via an audio replay device that does not contain the first track).

As will be appreciated the attractive feature of the described technique of assigning sequence numbers is that in principle an unlimited number of tracks can be added later at arbitrary positions in the playlist. If there is no room to add a new track at a chosen position using the existing number of bits in the sequence number, room can be created simply by (implicitly) extending the previously used numbers with a less significant binary zero. The extension of the number of bits of the old sequence numbers can be performed locally inside audio replay devices 12 once playlist information with a sequence number with a greater number of bits is received, or even be postponed until the playlist is played. Hence no central update of the sequence numbers is needed and it does not matter in which sequence playlist information items for the tracks are received.

It should be appreciated, however, that these advantages are not limited to the embodiment that has been illustrated with the aid of FIGS. 4a-e. Any technique of assigning sequence number that at least initially leaves room for additional sequence numbers between previously assigned sequence numbers may be used. For playlists that will not exceed a maximum length sequence numbers of a predetermined number of bits may be used. But if playlists of arbitrary lengths should be supported default extensions may be added to previously assigned sequence numbers to accommodate more sequence numbers, once this is needed to insert a later added track. As in the example of the figures these default extensions may consist of binary zeros, but of course other extensions may be used, even default extensions that are a function of the preceding bits.

FIG. 5 shows an example of a track format for download to audio replay devices 12. The track format contains a variable length field 50 the audio signal data, encoded for example according to the MP3 standard. Field 50 is preceded by fields 51, 52 for identification of a playlist to which the track belongs and for a sequence number of the track in that playlist.

Optionally fields 53, 54 are included for editing information that is to be used when the track is reproduced during replay according to the playlist. The editing information includes for example indications of a start point in the audio signal from which replay of the track should start and/or an end point where replay of the track should stop. More detailed editing information may be included, specifying for example parts of the track that must be skipped and/or play speeds. Upon replay, replay circuit 24 reads this information and replays the track edited according to this information.

In an embodiment only a single set of fields 51-54 is provided, so that one track can only be a member of one selectable playlist. However, in another embodiment a plurality of such sets of fields is provided, wherein each set of fields may be used to indicate a different playlist to which the track belongs and the position of the track in that playlist. Audio replay devices 12 may be designed to handle a variable number of such sets of fields for each track.

In one embodiment the set of fields 51-54 or sets of fields are transmitted included in the same data-structure with the audio signal data 50. However, in another embodiment the set or sets of fields may be transmitted separately in an update message from central apparatus 10 or an audio replay device 12 to an audio replay device 12, for example if the audio signal data 50 of a track is already stored in an audio replay device. In this case an additional identification of the track to which the fields apply should be provided.

In a further embodiment the central apparatus 10 and/or the audio replay devices 12 may be arranged to transmit update messages for a track such as a strip message for removing the track from a playlist, a “move” message to change the position of the track in the playlist, and/or a “change” message to change other playlist information for the track, such as editing information. Central apparatus 10 transmits such an update message for a track once an audio replay device 12 is connected to central apparatus after a user has removed a track form a playlist, changed its position in the playlist and/or changed other information. Preferably only update messages for communicating the most recent status of tracks in a playlist are transmitted. The audio replay device 12 that receives the update message effects the changes commanded by the update message. Preferably, the audio replay device 12 saves information about the changes, e.g. by saving the update message. When the audio replay device 12 is coupled to another audio replay device 12 it preferably forwards the update message to the other audio replay device 12. In an embodiment central apparatus 10 checks which playlist information is present in a connected audio replay device 12 and transmits update messages only for existing tracks with obsolete information. But in another embodiment more updates are sent, for later use during forwarding. A content-list may list, for example, audio tracks, video clips, cartoons or images. In an embodiment the content-list may have a tree-structure. The central apparatus may be able to reproduce audio and the audio replay device may be able to act as a central apparatus.

Although the invention has been illustrated using an embodiment using a central apparatus 10 and a audio replay device 12 with different components, it will be understood that in practice the different components may be implemented using the same circuits, or using suitably programmed programmable computers to implement any or all of the functions of the components. Accordingly the invention also encompasses computer program products with instructions which when executed by such a computer make the computer perform the invention. The computer program products may be stored on a record carrier or downloaded from a network, e.g. the Internet.

1. A method of distributing playlist information for use in a system of a plurality of audio replay devices (12) that each comprise local storage (20) for storing tracks, the method comprising:
defining playlist information items, each for a respective track, each indicating a system wide playlist to which the respective track belongs and a sequential position of the track in the system wide playlist;
coupling an individual audio replay device to a source device (10) for downloading selected playlist information items, for updating a local playlist in the individual audio replay device (12);
using the updated local playlist to control selection and a sequence of play of tracks by the individual audio replay device (12).

2. A method according to claim 1, wherein the playlist information item indicates the sequential position of the track in the system wide playlist and the local playlist by means of a sequence number for the track in the playlist, the sequence numbers of the playlist information items being set in the defining step so that space is left for later definition of playlist information items with sequence numbers that correspond to insertion among tracks in a previously defined playlist, the individual audio replay device (12) skipping sequence numbers for which it has not received playlist information items.

3. A method according to claim 2, wherein the sequence numbers are assigned leaving a combination of less significant bits of the rank numbers at least implicitly at a default value for an initial set of tracks in the playlist, and subsequently assigning a new sequence number wherein a most significant one of a combination of the least significant bits is set to a value that deviates the value of said bit in the default value, at least when needed to distinguish the new sequence number from previously assigned sequence numbers of tracks that are immediately adjacent to a new track in the playlist.

4. A method according to claim 1, wherein at least one of the playlist information items contains playlist specific virtual editing information (53, 54), the individual audio replay device (12) editing the track that is associated with the at least one of the playlist information items according to the virtual editing information and replaying the edited track when replaying the playlist.

5. A method according to claim 1, comprising sending update messages for said updating of playlist information in the audio replay devices (12).

6. A method according to claim 1, wherein one or more playlist information items that apply to a particular track are included in a file that contains the particular track and that is downloaded to download the particular track.

7. A method according to claim 1, wherein playlist information items contain time stamp information to resolve conflicts between inconsistent playlist information items.

8. A method according to claim 1, comprising coupling pairs of audio replay devices (12a, b) and passing selected playlist information items from one audio replay device (12a) of a pair to another (12b) when the pair is coupled.

9. A content-item exporting device (10), comprising:
a storage device (30) for storing a local ordered content-list and content items listed in the local content-list;
a position assigner for assigning a sequential position in a system wide content-list to new content items added to the local content-list; and
an output (38) for exporting a content item and content-list information for the content item to a content item importing device (12), the content-list information including said sequential position.

10. A content-item importing device (12), comprising:
local storage (20) for storing a local ordered content-list and content items listed in the local content-list;
an input (14) for importing a new content item and content-list information for the new content-item, the content-list information including a sequential position of the new content item in a system wide content-list; and
an updater for updating the local content-list according to the content-list information, the sequential position of the content item in the system wide content-list determining a sequential position of the content item in the local content-list.

11. A method of exporting content-list information, the method comprising the steps of:
enabling a user to order a local content-list;
assigning a sequential position in a system wide content-list to content items added to the local content-list; and
exporting a content item and content-list information for the content item to a content item importing device, the content-list information including the sequential position.

12. A computer program product with instructions which when executed by a computer make the computer perform the method of claim 11.

13. A method of importing content-list information, the method comprising the steps of:
importing a content item and content-list information for the content item, the content-list information including a sequential position of the content item in a system wide content-list; and
updating a local content-list using the content-list information, the sequential position of the audio track in the system wide content-list determining a sequential position of the content item in the local content-list.

14. A computer program product with instructions which when executed by a computer make the computer perform the method of claim 13.
